(19) United States
(12) Patent Application Publication
(10) Pub. No.: US 2025/0267766 A1
(43) Pub. Date: Aug. 21, 2025

(54) Heating Circuit and Heating Apparatus

(71) Applicants: Guangdong Midea White Home Appliance Technology Innovation Center Co., Ltd., Foshan (CN); Midea Group Co., Ltd., Foshan (CN)

(72) Inventors: Yuanyang ZUO, Foshan (CN); Jian HU, Foshan (CN); He LIU, Foshan (CN); Jiangping FENG, Foshan (CN); Lianghao WU, Foshan (CN); Lutian ZENG, Foshan (CN); Deyong JIANG, Foshan (CN); Jun LEI, Foshan (CN); Yunfeng WANG, Foshan (CN)

(21) Appl. No.: 19/201,558

(22) Filed: May 7, 2025

Related U.S. Application Data
(63) Continuation of application No. PCT/CN2023/130288, filed on Nov. 7, 2023.

(30) Foreign Application Priority Data
Nov. 8, 2022 (CN) 202211403345.2
Nov. 8, 2022 (CN) 202222988602.5

(51) Int. Cl. H05B 1/02

(52) U.S. Cl. CPC H05B 1/0202

(57) ABSTRACT

A heating circuit includes: at least two power supply circuits; at least two heating modules; and a selection circuit, connected with the at least two power supply circuits and the at least two heating modules, and configured to select at least one of the at least two power supply circuits to be connected to each of the at least two heating modules. Selecting the at least one power supply circuit for one of the at least two power supply circuits does not affect selecting the at least one power supply circuit for another one of the at least two power supply circuits.

### CROSS REFERENCE TO RELATED APPLICATIONS

The present application is a continuation application of the international patent application No. PCT/CN2023/130288, filed on Nov. 7, 2023, which claims the priority of the Chinese patent application No. 202211403345.2, filed on Nov. 8, 2022, titled “HEATING CIRCUIT AND HEATING DEVICE”; and the Chinese patent application No. 202222988602.5, filed on Nov. 8, 2022, titled “HEATING CIRCUIT AND HEATING DEVICE”, the contents of which are incorporated herein in their entireties.

### TECHNICAL FIELD

Embodiments of the present disclosure relate to the technical field of circuits, and more specifically, to a heating circuit and a heating device.

### BACKGROUND

In a heating circuit, a plurality of heating modules may be arranged. In some heating circuits, the plurality of heating modules may be fixedly connected to a plurality of power supply circuits; while in other heating circuits, when one of the plurality of heating modules is connected to one power supply circuit, power supply circuits that are available to be connected to the rest of the plurality of heating modules may be limited.

### SUMMARY

In some embodiments, the present disclosure provides a heating circuit and a heating device, such that power may be supplied to a plurality of heating modules more flexibly.

In a first aspect, the present disclosure provides a heating circuit, including: at least two power supply circuits; at least two heating modules; and a selection circuit, connected with the at least two power supply circuits and the at least two heating modules, and configured to select at least one of the at least two power supply circuits to be connected to each of the at least two heating modules. Selecting the at least one power supply circuit for one of the at least two power supply circuits does not affect selecting the at least one power supply circuit for another one of the at least two power supply circuits.

In some embodiments, the selection circuit includes at least two selection switches; each of the at least two selection switches is connected to a respective one of the at least two heating modules and a plurality of the at least two power supply circuits; each of the at least two selection switches is configured to select one power supply circuit from the plurality of the at least two power supply circuits connected thereto to be connected to the respective heating module connected to the selection switch.

In some embodiments, each of the at least two selection switches includes a first connection end and a plurality of second connection ends; the first connection end is connected to an input end of the respective one heating module; the plurality of second connection ends are connected to output ends of different ones of the at least two power supply circuits. When the first connection end is conducted to one of the plurality of second connection ends, the respective power supply circuit connected to the conducted one second connection end is conducted to the respective heating module connected to the selection switch, and the respective power supply circuit connected to any non-conducted second connection end of the plurality of second connection ends is disconnected to the respective heating module connected to the selection switch.

In some embodiments, two or more of the at least two selection switches, which are connected two or more of the at least two heating modules, are connected a same one of the at least two power supply circuits; and/or at least one of the at least two selection switches, which is connected to at least one of the at least two heating modules, is connected is connected to all of the at least two power supply circuits.

In some embodiments, each of the plurality of power supply circuits is an inverter circuit, and each of the at least two heating modules is a resonant circuit.

In some embodiments, the inverter circuit includes a power supply, a first control switch and a second control switch; a first connection end of the first control switch is connected to a first pole of the power supply; a second connection end of the first control switch is connected to a first connection end of the second control switch; a second connection end of the second control switch is connected to a second pole of the power supply; and a second connection end of the first control switch serves as the output end of the power supply circuit; and/or the resonant circuit includes a coil and an in-series capacitor circuit, the in-series capacitor circuit includes a first capacitor and a second capacitor connected in-series with the first capacitor, two ends of the in-series capacitor circuit are respectively connected to the first pole and the second pole of the power supply of the power supply circuit; one end of the coil is connected between the first capacitor and the second capacitor, and the other end of the coil serves as the input end of the heating module.

In a second aspect, the present disclosure provides a heating device, including a control circuit and the heating circuit in the first aspect. The control circuit is configured to control the selection circuit in the heating circuit to select the at least one power supply circuit for supplying power to each of the at least two heating modules in the heating circuit.

In some embodiments, the control circuit is configured to: select a target power supply circuit for a respective one of the at least two heating modules from selectable power supply circuits of the respective heating module based on a required power of the respective heating module and/or based on a state of each of the selectable power supply circuits; and control the selection circuit to connect the respective heating module to the target power supply circuit, wherein the selectable power supply circuits are power supply circuits that are connected to the selection circuit connected to the respective heating module.

In some embodiments, an output power of the target power supply circuit of the respective heating module matches the required power of the respective heating module; and/or the state of the power supply circuit includes: the power supply circuit being in an idle state or in a non-idle state, wherein the idle state indicates that the power supply circuit is not currently connected to any of the at least two heating modules.

In some embodiments, selecting the target power supply circuit for the respective one of the at least two heating modules from selectable power supply circuits of the respective heating module based on the required power of the respective heating module and/or based on the state of each of the selectable power supply circuits, includes: searching from the selectable power supply circuits of the respective heating module to determine whether an idle power supply circuit exists, wherein the idle power supply circuit is one of the selectable power supply circuits having an output power matching the required power of the respective heating module and being in the idle state; in response to the idle power supply circuit existing, selecting the idle power supply circuit as the target power supply circuit for the respective heating module; in response to the idle power supply circuit not existing, selecting, from the selectable power supply circuits, one power supply circuit which has the output power matching the required power of the respective heating module and is in an in-use state, as the target power supply circuit for the respective heating module.

In some embodiments, the control circuit is further configured to control the selection circuit to connect at least a portion of the at least two heating modules having a same required power to a same one of the at least two power supply circuits.

In some embodiments, the heating device further includes a detection circuit, the detection circuit is configured to: detect whether a to-be-heated target object exists in each of the at least two heating modules; and generate, in response to the to-be-heated target object existing in any of the at least two heating modules, a trigger signal for the any heating module in which the to-be-heated target object exists; the control circuit is configured to control, in response to the trigger signal, the selection circuit to connect the heating module in which the to-be-heated target object exists to at least one of the at least two power supply circuits.

In some embodiments, the control circuit is further configured to control the selection circuit to connect a plurality of the at least two heating modules in which the same to-be-heated target object exists to the same power supply circuit.

In some embodiments, the heating device is an electromagnetic heating device.

According to the present disclosure, the selection circuit is connected to at least two power supply circuits and at least two heating modules to select at least one of the at least two power supply circuits to be connected to each of the at least two heating modules respectively. Selecting the at least one power supply circuit for one of the at least two heating modules does not affect selecting the at least one power supply circuit for another one of the at least two heating modules. Since the selection circuit, which is connected to each heating module, is connected to the at least two power supply circuits, the selection circuit can select any power supply circuit or any plurality of power supply circuits from the at least two power supply circuits for the heating module connected thereto. In this way, connection of the heating module to any power supply circuit in the heating circuits can be achieved, i.e., to the power may be flexibly supplied to the heating module.

### BRIEF DESCRIPTION OF THE DRAWINGS

In order to more clearly illustrate technical solutions in embodiments of the present disclosure, accompanying drawings used in the embodiments will be briefly introduced below.

FIG. 1 is a structural schematic view of a heating circuit according to some embodiments of the present disclosure.

FIG. 2 is a structural schematic view of the heating circuit according to some embodiments of the present disclosure.

FIG. 3 is a structural schematic view of a heating device according to some embodiments of the present disclosure.

FIG. 4 is a structural schematic view of the heating device according to some embodiments of the present disclosure.

### DETAILED DESCRIPTIONS

It should be noted that when the embodiments in the present disclosure are described by involving the “first”, the “second”, and so on, the “first”, the “second”, and so on are only used for descriptive purposes, and shall not be interpreted as indicating or implying relative importance thereof or implicitly specifying the number of technical features. Therefore, a feature defined with the “first” or the “second” may include at least one such feature, explicitly or implicitly. In addition, technical solutions of various embodiments may be combined with each other, but only on the basis that the combination can be achieved by any ordinary skilled person in the art. When a combination results in contradictory or is unachievable, the combination shall be considered as not existing and is not included in the scope of the present disclosure.

In order to better understand the present disclosure, a heating circuit and a heating device provided in the present disclosure will be described in detail below based on the accompanying drawings and specific embodiments.

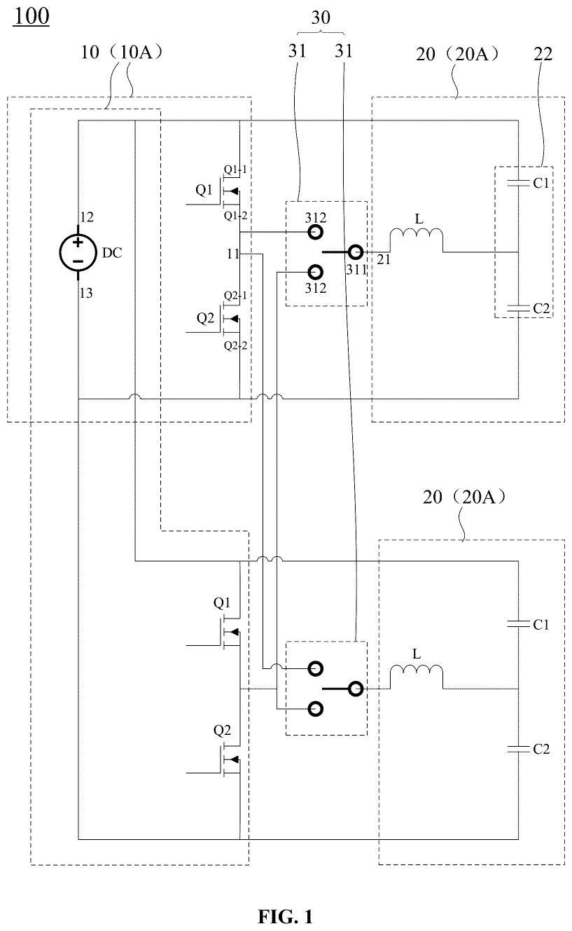

As shown in FIG. 1, FIG. 1 is a structural schematic view of a heating circuit according to some embodiments of the present disclosure. The heating circuit 100 includes at least two power supply circuits 10, at least two heating modules 20, and a selection circuit 30.

The at least two power supply circuits 10 are power supply portions that supply electricity power to the heating circuit 100. That is, the at least two power supply circuits 10 serve as a source of electrical energy for the heating circuit 100 for supplying power to other related circuits or components in the heating circuit 100 to enable or ensure the other related circuits or the components to operate properly. In this way, the heating circuit 100 may operate properly. To be noted that the at least two power supply circuits 10 may respectively supply power to different circuits or components. That is, the at least two power supply circuits 10 do not affect each other and are not associated to each other. That is, when the heating circuit 100 is operating, the at least two power supply circuits 10 may simultaneously supply power, or each of the at least two power supply circuits 10 may individually supply power. Any one of the at least two power supply circuits 10 supply or not supplying power is determined based on whether a relevant circuit or a component connected to the one of the at least two power supply circuits 10 needs to be powered. The number of the at least two power supply circuits 10 is not limited herein and may be determined according to actual demands. For example, the number of the at least two power supply circuits 10 may be 2, 3, 4, 5 or more.

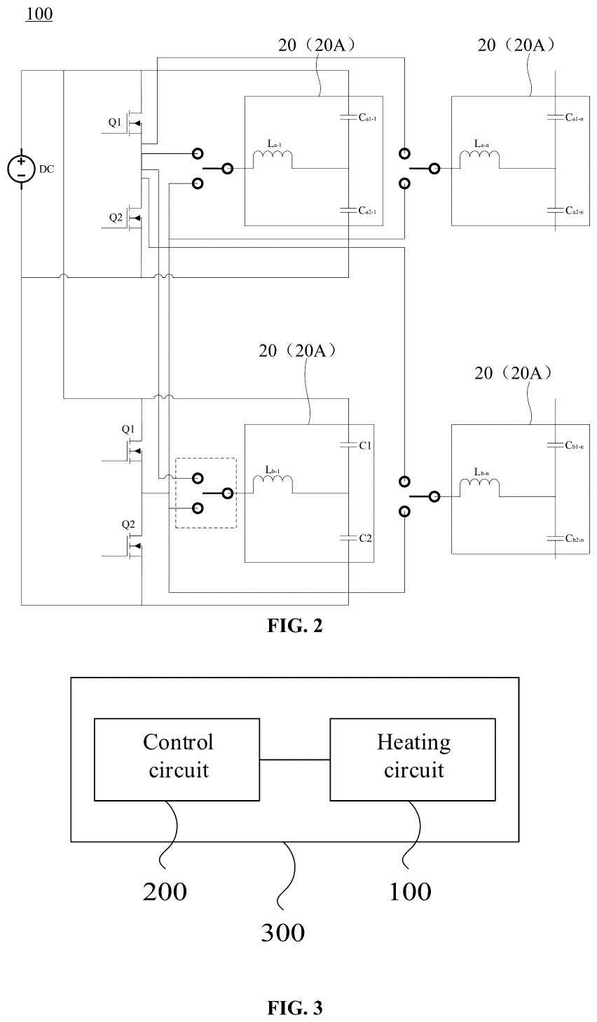

The at least two heating modules 20 may be configured to heat a to-be-heated target object that is located on regions corresponding to the at least two heating modules 20. The at least two heating modules 20 may be configured to heat different to-be-heated target objects or one to-be-heated target object. Alternatively, a portion of the at least two heating modules 20 may be configured to heat one to-be-heated target object, and another portion of the at least two heating modules 20 may be configured to heat another to-be-heated target object. For example, the heating circuit 100 may include four heating modules 20, which are a heating module 20 A, a heating module 20 B, a heating module 20 C, and a heating module 20 D. A region in which a to-be-heated target object α is located may be a region corresponding to the heating module 20 A and the heating module 20 B. Therefore, the heating module 20 A and the heating module 20 B may be controlled to heat the to-be-heated target object α. Alternatively, the heating module 20 A or the heating module 20 B may be controlled to heat the to-be-heated target object α as desired. A region in which a to-be-heated target object β is located may be a region corresponding to the heating module 20 C, and therefore, the heating module 20 C may be controlled to heat the to-be-heated target object β. When no to-be-heated target object is located on a region corresponding to the heating module 20 C, the heating module 20 C may not operate. In another example, the heating circuit 100 may include three heating modules 20, which are the heating module 20 A, the heating module 20 B, and the heating module 20 C. A region in which a to-be-heated target object γ is located is a region corresponding to the heating module 20 A, the heating module 20 B, and the heating module 20 C. Therefore, the heating module 20 A, the heating module 20 B, and the heating module 20 C may be controlled to simultaneously heat the to-be-heated target object. Alternatively, any one or any two of the heating module 20 A, the heating module 20 B, and the heating module 20 C may be controlled to heat the to-be-heated target object γ. In some embodiments, the number of the at least two heating modules 20 is not limited herein and may be determined according to actual demands. For example, as shown in FIG. 1, the number of the at least two heating modules 20 may be 2; and for example, as shown in FIG. 2, FIG. 2 is a structural schematic view of the heating circuit according to some embodiments of the present disclosure, where the at least two heating modules 20 may be more than two.

The selection circuit 30 is connected to the at least two power supply circuits 10 and the at least two heating modules 20 and is configured to select at least one of the at least two power supply circuits 10 to be connected to each of the at least two heating modules 20. That is, by arranging the selection circuit 30, each of the at least two heating modules 20 is enabled to be connected to at least one power supply circuit 10, and the power supply circuit 10 which is correspondingly connected to the heating module 20 serves as a source of electrical energy for the corresponding heating module 20 to supply power to the corresponding heating module 20 to ensure or maintain the corresponding heating module 20 to operate properly. In this way, the heating module 20 may be able to heat the to-be-heated target object located on the region corresponding to the instant heating module 20. In addition, selecting, by the selection circuit 30, the at least one power supply circuit 10 for one of the at least two heating modules 20 does not affect selecting, by the selection circuit 30, the at least one power supply circuit 10 for another one of the at least two heating modules 20. That is, for each of the at least two heating modules 20, the selection circuit 30 may select any one or any plurality of the at least two power supply circuits 10 that is connected to the selection circuit 30 to be connected to the heating module 20, such that the heating module 20 may be connected to any one or any plurality of the at least two power supply circuits 10, and the connection may not be affected by whether or not the any one or any plurality of power supply circuits 10 are connected to other heating modules 20. That is, selection of any one or any plurality of power supply circuits 10 for the heating module 20 is unlimited, such that the power supply to the heating module 20 can be achieved flexibly. In an example, the heating circuit 100 may include two power supply circuits 10 and two heating modules 20, and the selection circuit 30 may select one of the two power supply circuits 10 to be connected to each of the two heating modules 20. The selection circuit 30 may be connected to both of the two power supply circuits 10 (specifically, a power supply circuit 10 a and a power supply circuit 10 b) and to both of the two heating modules 20 (specifically, a heating module 20 A and a heating module 20 B). The selection circuit 30 may select one of the power supply circuit 10a and the power supply circuit 10 b to be connected to the heating module 20 A. For example, the power supply circuit 10 b may be selected to be connected to the heating module 20 A. After the selection circuit 30 selects the power supply circuit 10 b to be connected to the heating module 20 A, the selection circuit 30 may select one of the power supply circuit 10a or the power supply circuit 10 b to be connected to the heating module 20 B.

Further as shown in FIG. 1, in some embodiments, the selection circuit 30 may include at least two selection switches 31. Each of the at least two selection switches 31 is connected to one of the at least two heating modules 20 and a plurality of the at least two power supply circuits 10. Each of the at least two selection switches 31 may be configured to select, from the plurality of power supply circuits 10 connected to the selection switch, one power supply circuit 10 to be connected to the heating module 20 connected to the selection switch 31. Since each selection switch 31 is connected to the plurality of power supply circuits 10, the selection switch 31 may select any one power supply circuit 10 from the plurality of power supply circuits 10 connected to the selection switch 31 to be connected to the heating module 20 that is connected to the selection switch 31. That is, selecting the power supply circuit 10 by one of the at least two selection switches 31 for the heating module 20 connected thereto does not affect selecting the power supply circuit 10 by another one of the at least two selection switches 31 for the heating module 20 connected thereto. The number of the at least two selection switches 31 is not limited herein and can be determined according to the number of the at least two heating modules 20. For example, the heating circuit 100 may include 4 heating modules 20, and therefore, 4 selection switches 31 may be arranged. Each of the 4 selection switches 31 may be connected to a respective one of the 4 heating modules 20. It is understood that in other embodiments, the selection circuit 30 may be configured in other forms, which may be determined according to actual demands and is not specifically limited herein.

In some embodiments, at least one of the at least two selection switches 31 connected to at least one of the at least two heating modules 20 may be connected to all of the at least two power supply circuits 10. That is, a portion of the at least two selection switches 31 in the heating circuit 100 may be connected to all of the at least two power supply circuits 10 in the heating circuit 100. In this way, the at least one selection switch 31 may select, from all of the at least two power supply circuits 10 included in the heating circuit 100, any one power supply circuit 10 to be connected to the at least one heating module 20 that is connected to the at least one selection switch 31. The number of the at least one selection switch 31 connected to all of the at least two power supply circuits 10 may not be limited herein and may be specifically determined according to the actual demands. For example, selection switches 31 connected to one or two or three heating modules 20 may be connected to all of the at least two power supply circuits 10. In some embodiments, selection switches 31 connected to two or more heating modules 20 may be connected to one power supply circuit 10. That is, a portion of the at least two power supply circuits 10 in the heating circuit 100 may be connected to two or more selection switches 31 at the same time.

In an example, the heating circuit 100 may include the heating module 20 A, the heating module 20 B, the heating module 20 C, the power supply circuit 10 a, the power supply circuit 10 b, and the power supply circuit 10 c. A selection switch 31 that is connected to the heating module 20 A may be connected to the power supply circuit 10 a, the power supply circuit 10 b, and the power supply circuit 10 c. A selection switch 31 that is connected to the heating module 20 B may be connected to the power supply circuit 10 a and the power supply circuit 10 c. A selection switch 31 that is connected to the heating module 20 C may be connected to the power supply circuit 10 a and the power supply circuit 10 b.

In some embodiments, as shown in FIG. 1, each of the at least two selection switches 31 may include a first connection end 311 and a plurality of second connection ends 312. The first connection end 311 of the selection switch 31 is connected to an input end 21 of the respective heating module 20. Each of the plurality of second connection ends 312 of the selection switch 31 is connected to an output end 11 of a respective one of the at least two power supply circuits 10. When the first connection end 311 of the selection switch 31 is connected to one of the plurality of second connection ends 312, the respective power supply circuit 10 connected to the one second connection end 312 that is currently conducted may be connected to the heating module 20 connected the selection switch 31. That is, the selection circuit 30 may be configured as a single-pole multi-throw relay. A plurality of movable ends of the single-pole multi-throw relay may be connected to output ends 11 of different power supply circuits 10. When an immovable end of the single-pole multi-throw relay is connected to one of the plurality of movable ends, the immovable end may be conducted with the one movable end, such that the power supply circuit 10 connected to the movable end and the heating module 20 connected to the immovable end may be conducted to each other. Therefore, the power supply circuit 10 may supply power to the heating module 20, ensuring or maintaining the heating module 20 to operate properly, and the heating module 20 may heat the to-be-heated target objected located on the region corresponding to the heating module 20.

As shown in FIG. 1, in some embodiments, as shown in FIG. 1, the power supply circuit 10 may be an inverter circuit 10A, and the heating module 20 may be a resonance circuit 20A. Since the inverter circuit 10A may convert a direct current into an alternating current, when the power supply circuit 10 is the inverter circuit 10A, the power supply circuit 10 may be an alternating current power source. That is, the power supply circuit 10 may output an alternating current electric signal. Essence of the resonance circuit 20A may be that an electric field energy in a capacitor and a magnetic field energy in an inductor may be converted to each other, and a sum of the electric field energy and the magnetic field energy may remain constant at all times. The power supply may not have to convert energy back and forth with the capacitor or the inductor and may only need to supply an electrical energy that may be consumed by a resistor in the circuit. That is, when the power supply circuit 10 is the inverter circuit 10A and the heating module 20 is the resonant circuit 20A, the heating circuit 100 may specifically be an electromagnetic heating circuit, and the inverter circuit 10A in the electromagnetic heating circuit may invert the electric signal into a high-frequency alternating current. The resonant circuit 20A in the electromagnetic heating circuit may convert the high-frequency alternating current into a high-frequency alternating magnetic field and generate an eddy current corresponding to the high-frequency alternating magnetic field. When the eddy current flows on a surface of the inductor, electrons inside a metal may move significantly actively and may collide with each other, such that a conductor material inside the inductor may be heated and warmed up. Specific circuit structures of the inverter circuit 10A and the resonant circuit 20A may not be limited herein and may be determined according to the actual demands. It is understood that in other embodiments, the heating module 20 may alternatively be configured as a circuit in other types, and the power supply circuit 10 may alternatively be configured as a circuit in other types, which may not be specifically limited herein. For example, the power supply circuit 10 may be a rectifier circuit and the like.

In an example, a plurality of resonant circuits may be arranged in the electromagnetic heating circuit. In the art, when a plurality of resonant circuits are arranged in the electromagnetic heating circuit, and when one of the plurality of resonant circuits is connected to a lower half-bridge or an upper half-bridge of a half-bridge inverter circuit, connection of the rest of the plurality of resonant circuits to either half-bridge of the half-bridge inverter circuit may be affected. In the present disclosure, by arranging the selection circuit 30, each of the plurality of resonant circuits 20A may be connected to at least one inverter circuit 10A, and the inverter circuit 10A correspondingly connected to the resonant circuit 20A may serve as a source of electrical energy for the resonant circuit 20A and supply power to the resonant circuit 20A to ensure or maintain the resonant circuit 20A to operate properly. In this way, the resonant circuit 20A may heat the to-be-heated target object located on the region corresponding to the resonant circuit 20A. Furthermore, selecting, by the selection circuit 30, one inverter circuit 10A for one resonant circuit 20A does not affect selecting, by the selection circuit 30, one inverter circuit 10A for another resonant circuit 20A. That is, for each resonant circuit 20A, the selection circuit 30 may select any one or more of the at least two inverter circuits 10A that is connected to the selection circuit 30 to be connected to the resonant circuit 20A, enabling the resonant circuit 20A to be connected to any one or more of the at least two inverter circuits 10A, and the connection is not affected by whether the selected inverter circuit 10A is connected to any other resonant circuit 20A. That is, selection of the inverter circuit 10A for the resonant circuit 20A is unlimited, such that power supply to the resonant circuit 20A may be flexible.

In some embodiments, as shown in FIG. 1, the inverter circuit 10A may be the half-bridge inverter circuit. Specifically, the inverter circuit 10A may include a power supply DC, a first control switch Q1, and a second control switch Q2. A first connection end Q1-1 of the first control switch Q1 may be connected to a first pole 12 of the power supply DC, a second connection end Q1-2 of the first control switch Q1 may be connected to a first connection end Q2-1 of the second control switch Q2. A second connection end Q2-2 of the second control switch Q2 may be connected to a second pole 13 of the power supply DC. The second connection end Q1-2 of the first control switch Q1 may serve as the output end 11 of the power supply circuit 10. It is understood that, in other embodiments, the inverter circuit 10A may be a full-bridge inverter circuit or the like, which may be determined according to the actual demands. In some embodiments, as shown in FIG. 1, the at least two inverter circuits 10A may share one power supply DC. Of course, in other embodiments, the at least two inverter circuits 10A may have different power supplies DC from each other, which will not be limited herein.

In some embodiments, each of the first control switch Q1 and the second control switch Q2 may be a transistor, which may be a metal-oxide-semiconductor field-effect transistor (MOSFET). The MOSFET may be widely applied in analog and digital circuits. Alternatively, each of the first control switch Q1 and the second control switch Q2 may be an insulated-gate bipolar transistor or the like. The insulated-gate bipolar transistor may be a composite fully-controlled voltage-driven power semiconductor device formed by a bipolar transistor and the insulated-gate field-effect transistor. The insulated-gate bipolar transistor may have a high input impedance of the MOSFET and a low on-state voltage drop of a power transistor.

In some embodiments, the resonant circuit 20A may include a coil L and an in-series capacitance circuit 22. The in-series capacitance circuit 22 may include a first capacitor C1 and a second capacitor C2 that is connected in series to the first capacitor C1. Two ends of the in-series capacitance circuit 22 may be connected to two poles of the power supply DC of the power supply circuit 10. One end of the coil L may be connected between the first capacitor C1 and the second capacitor C2, and the other end of the coil L may serve as the input end 21 of the heating module 20. In other embodiments, only one capacitor or three or four or more than four capacitors may be arranged in the resonant circuit 20A, which will not be limited herein.

In some embodiments, each of the first capacitor C1 and the second capacitor C2 included in the in-series capacitor circuit 22 may be a resonant capacitor.

According to the present disclosure, the heating circuit is provided. The heating circuit may include at least two power supply circuits, at least two heating modules, and the selection circuit. The selection circuit may be connected to the at least two power supply circuits and the at least two heating modules and may be configured to select at least one of the at least two power supply circuits to be connected to each of the at least two heating modules. Selecting, by the selection circuit, the at least one power supply circuit for one of the at least two heating modules does not affect selecting, by the selection circuit, the at least one power supply circuit for another one of the at least two heating modules. Since the selection circuit connected to each of the at least two heating modules is connected to the at least two power supply circuits, the selection circuit may select any one or more power supply circuits from the at least two power supply circuits to be connected to the heating module connected to the selection circuit, such that the heating module may be connected to any of the at least two power supply circuits of the heating circuit.

As shown in FIG. 3, FIG. 3 is a structural schematic view of a heating device according to some embodiments of the present disclosure. The present disclosure further provides a heating device 300, the heating device 300 may include a control circuit 200 and the heating circuit 100 in any of the above embodiments. The control circuit 200 may be configured to control the selection circuit 30 in the heating circuit 100 to select the power supply circuit 10 for supplying power to the respective heating module 20 in the heating circuit 100. In the heating circuit 100 of any of the above embodiments, since the selection circuit 30 connected to each heating module 20 is connected to at least two power supply circuits 10, the control circuit 200 may control the selection circuit 30 to select any one or more power supply circuits 10 from the at least two power supply circuits 10 to be connected to the heating module 20 that is connected to the selection circuit 30. In this way, selecting the power supply circuits 10 that supply power to the respective heating module 20 in the heating circuit 100 may be achieved, and that is, selection of the power supply circuit 10 for the heating module 20 is unlimited, and power supply for the heating modules 20 may be flexible. In some embodiments, the heating device 300 may be an electromagnetic heating device. The heating circuit 100 may specifically be the electromagnetic heating circuit. The inverter circuit 10A in the electromagnetic heating circuit may invert the electric signal into the high-frequency alternating current, and the resonant circuit 20A in the electromagnetic heating circuit may convert the high-frequency alternating current into the high-frequency alternating magnetic field. The high-frequency alternating magnetic field passes through the conductor in the coil L to generate an induced current to form a closed circuit, i.e., the eddy current. When the eddy current flows on the surface of the material, the electrons inside the metal may move significantly actively and may collide with each other, such that the conductor material inside the coil L may be heated and warmed up, and the heating device 300 may heat the to-be-heated target object. The electromagnetic heating circuit may effectively improve a thermal conversion rate and greatly reduce energy consumption, and may have less safety hazards.

In some embodiments, the heating device 300 may further include a detection circuit (not shown in the drawings), the detection circuit may be configured to detect whether the to-be-heated target object exists in each heating module 20 and configured to generate, in response to the to-be-heated target object existing, a trigger signal for the heating module 20 indicating that the to-be-heated target object exists. At this moment, the control circuit 200 may be configured to control, in response to the trigger signal generated by the detection circuit, the selection circuit 30 to connect the heating module 20 in which the to-be-heated target object exists to the at least one power supply circuit 10. That is, the detection circuit may detect the region corresponding to each heating module 20 to determine whether or not the to-be-heated target object exists in the region corresponding to each heating module 20. When the to-be-heated target object exists in the region corresponding to any heating module 20, the detection circuit may generate the trigger signal for the heating module 20 in which the to-be-heated target object exists and sends the trigger signal to the control circuit 200. After the control circuit 200 receives the trigger signal sent from the detection, the control selection circuit 30 may connect the heating module 20 in which the to-be-heated target object exists to the at least one power supply circuit 10 to enable the power supply circuit 10 to supply power to the heating module 20, such that the heating module 20 may heat the to-be-heated target object existing in the region corresponding to the heating module 20.

In an example, the heating circuit 100 may include the heating module 20 A, the heating module 20 B, and the heating module 20 C. The detection circuit may detect the region corresponding to the heating module 20 A, the region corresponding to the heating module 20 B, and the region corresponding to the heating module 20 C; and may determine that the to-be-heated target object exists in the region corresponding to the heating module 20 A. At this moment, the detection circuit may generate the trigger signal for the heating module 20 A in which the to-be-heated target object exists and send the trigger signal to the control circuit 200. After the control circuit 200 receives the trigger signal sent by the detection circuit, the control circuit 200 may control the selection circuit 30 to connect the heating module 20 A in which the to-be-heated target object exists to the at least one power supply circuit 10 to enable the power supply circuit 10 to supply power to the heating module 20 A. In this way, the heating module 20 A may heat the to-be-heated target object existing in the region corresponding to the heating module 20 A.

In some embodiments, the control circuit 200 may further be configured to control the selection circuit 30 to connect a plurality of heating modules 20 in which one to-be-heated target object exists to one power supply circuit 10. In other words, the plurality of heating modules 20 in which one to-be-heated target object exists is regarded as one heating module group. A portion of all heating modules 20 in the heating circuit 100 may be combined to each other according to the to-be-heated target object to form the heating module group corresponding to the to-be-heated target object, and the heating module group may be connected to one power supply circuit 10 in the heating circuit 100. In this way, the power supply circuit 10 may supply power to each heating module 20 in the heating module group 20.

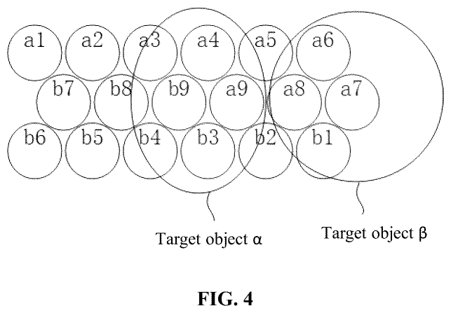

In an example, as shown in FIG. 4, FIG. 4 is a structural schematic view of the heating device according to some embodiments of the present disclosure. The to-be-heated target object α may be located in regions corresponding to a heating module a3, a heating module a4, a heating module b8, a heating module b9, a heating module a9, a heating module b3, and a heating module b4. The heating module a3, the heating module a4, the heating module b8, the heating module b9, the heating module a9, the heating module b3, and the heating module b4 may be combined to form a heating module group corresponding to the to-be-heated target object α. The control circuit 200 may control selection circuits 30, which are respectively connected to the heating module a3, the heating module a4, the heating module b8, the heating module b9, the heating module a9, the heating module b3, and the heating module b4, to be connected to one power supply circuit 10. In another example, the to-be-heated target object β may be located in regions corresponding to a heating module a6, a heating module a7, a heating module a8, and a heating module b1. The heating module a6, the heating module a7, the heating module a8, and the heating module b1 may be combined to form a heating module group corresponding to the to-be-heated target object β. The control circuit 200 may control selection circuit 30s, which are respectively connected to the heating module a6, the heating module a7, the heating module a8, and the heating module b1 having the to-be-heated target object β, to be connected to one power supply circuit 10.

In some embodiments, the control circuit 200 may be configured to: select a target power supply circuit for the heating module 20 from all selectable power supply circuits for the heating module 20 based on a required power of the heating module 20 and/or a state of each power supply circuit 10; and control the selection circuit 30 to connect the heating module 20 to the target power supply circuit. The selectable power supply circuits for the heating module 20 may be power supply circuits connected to the selection circuit 30 that is connected to the heating module 20. That is, the control circuit 200 may firstly select, based on the required power of the heating module 20 and/or based on the state of the power supply circuit 10, the target power supply circuit from the power supply circuits 10 connected to the selection circuit 30 that is connected to the heating module 20. Subsequently, the control circuit 200 may control the selection circuit 30 to connect the heating module 20 to the target power supply circuit. That is, the control circuit 200 may reasonably select the power supply circuit 10 to supply power to each heating module 20 in the heating circuit 100 based on factors such as the required power of the heating module 20 and/or the state of the power supply circuit 10, in this way, a utilization rate of the power supply circuit 10 in the heating circuit 100 may be improved, such that the heating device 300 may heat more target objects.

In some embodiments, the state of the power supply circuit 10 may include: the power supply circuit 10 being in an idle state or in a non-idle state. The idle state may indicate that the power supply circuit 10 currently is not connected to any heating module 20. Therefore, the control circuit 200 may select any one or more power supply circuits 10 in the idle state from the selectable power supply circuits of the heating module 20 as the target power supply circuit; and may control the selection circuit 30 to connect the heating module 20 to the target power supply circuit. For example, the heating circuit 100 may include the heating module 20 A and the heating module 20 B; power supply circuits 10 connected to the selection circuit 30 that is connected to the heating module 20 A may include the power supply circuit 10 a, the power supply circuit 10 b, and the power supply circuit 10 c; and power supply circuits 10 connected to the selection circuit 30 that is connected to the heating module 20 B may include the power supply circuit 10 a, the power supply circuit 10 b, and the power supply circuit 10 c. The power supply circuit 10 a may be already connected to the heating module 20 B. Therefore, the power supply circuit 10 that is currently in the idle state may be the power supply circuit 10 b and the power supply circuit 10 c. Therefore, the control circuit 200 may select the target power supply circuit from the power supply circuit 10 b and the power supply circuit 10 c that are in the idle state; and may control the target power supply circuit to be connected to the heating module 20 A.

In some embodiments, an output power of the target power supply circuit of the heating module 20 may match the required power of the heating module 20. Therefore, the control circuit 200 may select, based on the required power of the heating module 20, a power supply circuit 10 which has an output power matching the required power of the heating module 20 from the selectable power supply circuits of the heating module 20 as the target power supply circuit of the heating module 20; and may control the selection circuit 30 to connect the heating module 20 to the target power supply circuit. For example, the heating circuit 100 may include the heating module 20 A, and power supply circuits 10 connected to the selection circuit 30 that is connected to the heating module 20 A may include the power supply circuit 10 a, the power supply circuit 10 b, and the power supply circuit 10 c. The required power of the A heating module 20 may match an output power of the power supply circuit 10 a. Therefore, the control circuit 200 may select the power supply circuit 10 a, which has the output power matching the required power of the heating module 20, from the selectable power supply circuits of the heating module 20 as the target power supply circuit, and may control the target power supply circuit to be connected to the heating module 20 A.

In some embodiments, the control circuit 200 selecting the target power supply circuit for the heating module 20 from the selectable power supply circuits of the heating module 20 based on the required power of the heating module 20 and/or the state of the power supply circuit 10, may specifically include the following. The control circuit 200 may search from the selectable power supply circuits of the heating module 20 to determine whether any idle power supply circuit exists. The idle power supply circuit may be a selectable power supply circuit having the output power matching the required power of the heating module 20 and being in the idle state. In response to the idle power supply circuit existing, the control circuit 200 may select the idle power supply circuit as the target power supply circuit of the heating module 20. In response to the idle power supply circuit not existing, the control circuit 200 may select a selectable power supply circuit, which has the output power matching the required power of the heating module 20 and is in an in-use state, as the target power supply circuit of the heating module 20. For example, the heating circuit 100 may include the heating module 20 A, and the power supply circuit 10, which is connected to the selection circuit 30 connected to the heating module 20 A, may include the power supply circuit 10 a, the power supply circuit 10 b, and the power supply circuit 10 c. Firstly, the control circuit 200 may search from the selectable power supply circuits of the heating module 20, i.e., the power supply circuit 10 a, the power supply circuit 10 b, and the power supply circuit 10 c, to determine whether or not the idle power supply circuit exists. The power supply circuit 10 a may be currently in the idle state and may have the output power matching the required power of the heating module 20 A. Therefore, the power supply circuit 10 a may be the idle power supply circuit included in the selectable power supply circuits of the heating module 20. Subsequently, the idle power supply circuit, i.e., the power supply circuit a, may be selected as the target power supply circuit of the heating module 20. In another example, the heating circuit 100 may include the heating module 20 A, and the power supply circuits 10, which are connected to the selection circuit 30 connected to the heating module 20 A, may include the power supply circuit 10 a and the power supply circuit 10 b. Firstly, the control circuit 200 may search from the selectable power supply circuits of the heating module 20, i.e., the power supply circuit 10 a and the power supply circuit 10 b, to determine whether or not the idle power supply circuit exists. The power supply circuit 10 a may be a power supply circuit 10 having the output power matching the required power of the heating module 20 but being in the non-idle state, i.e., in the in-use state. The power supply circuit 10 b may be a power supply circuit 10 which has an output power not matching the required power of the heating module 20. Therefore, the selectable power supply circuits of the heating module 20 may not include the idle power supply circuit. Subsequently, the selectable power supply circuit, which has the output power matching the required power of the heating module 20 and is in the in-use state, i.e., the power supply circuit 10 a, may be selected as the target power supply circuit for the heating module 20.

In some embodiments, the control circuit 200 may further be configured to control the selection circuit 30 to connect at least some heating modules 20 having a same required power to the same power supply circuit 10. In an example, the heating circuit 100 may include the heating module 20 A, the heating module 20 B, and the heating module 20 C. The power supply circuits 10, which are connected to the selection circuit 30 connected to the heating module 20 A, may include the power supply circuit 10 a, the power supply circuit 10 b, and the power supply circuit 10 c. The power supply circuits 10, which are connected to the selection circuit 30 connected to the heating module 20 B, may include the power supply circuit 10 a, the power supply circuit 10 b, and the power supply circuit 10 c. The power supply circuits 10, which are connected to the selection circuit 30 connected to the heating module 20 C, may include the power supply circuit 10 a, the power supply circuit 10 b, and the power supply circuit 10 c. When the heating module 20 A, the heating module 20 B, and the heating module 20 C require the same required power, which matches the output power of the power supply circuit 10 a in the idle state and the output power of the power supply circuit 10 b in the idle state, the control circuit 200 may control the selection circuit 30 to connect the heating module 20 A and the heating module 20 B to the power supply circuit 10 a and connect the heating module 20 C to the power supply circuit 10 b. Alternatively, the control circuit 200 may control the selection circuit 30 to connect the heating module 20 A, the heating module 20 B, and the heating module 20 C to the power supply circuit 10 a or the power supply circuit 10 b.

The foregoing shows only implementations of the present disclosure, and does not intend to limit the scope of the present disclosure. Any equivalent structure or equivalent process transformation performed based on contents of the specification and the accompanying drawings of the present disclosure, applied directly or indirectly in other related technical fields, shall be equivalently included in the scope of the present disclosure.

What is claimed is:

1. A heating circuit, comprising:
at least two power supply circuits;
at least two heating modules; and
a selection circuit, connected with the at least two power supply circuits and the at least two heating modules, and configured to select at least one of the at least two power supply circuits to be connected to each of the at least two heating modules, wherein selecting the at least one of the at least two power supply circuits does not affect selecting the at least one power supply circuit for another one of the at least two power supply circuits.

2. The heating circuit according to claim 1, wherein the selection circuit comprises at least two selection switches; each of the at least two selection switches is connected to a respective one of the at least two heating modules and a plurality of the at least two power supply circuits; each of the at least two selection switches is configured to select one power supply circuit from the plurality of the at least two power supply circuits connected thereto to be connected to the respective heating module connected to the selection switch.

3. The heating circuit according to claim 2, wherein each of the at least two selection switches comprises a first connection end and a plurality of second connection ends; the first connection end is connected to an input end of the respective one heating module; each of the plurality of second connection ends is connected to an output end of a respective one of the at least two power supply circuits, the respective one of the at least two power supply circuits connected to one of the plurality of second connection ends is different from the respective one of the at least two power supply circuits that is connected to another one of the plurality of second connection ends;
when the first connection end is conducted to one of the plurality of second connection ends, the respective power supply circuit connected to the conducted one second connection end is conducted to the respective heating module connected to the selection switch, and the respective power supply circuit connected to any non-conducted second connection end of the plurality of second connection ends is disconnected from the respective heating module connected to the selection switch.

4. The heating circuit according to claim 2, wherein two or more of the at least two selection switches, which are connected two or more of the at least two heating modules, are connected
a same one of the at least two power supply circuits; and/or
at least one of the at least two selection switches, which is connected to at least one of the at least two heating modules, is connected is connected to all of the at least two power supply circuits.

5. The heating circuit according to claim 1, wherein each of the at least two power supply circuits is an inverter circuit, and each of the at least two heating modules is a resonant circuit.

6. The heating circuit according to claim 5, wherein,
the inverter circuit comprises a power supply, a first control switch and a second control switch; a first connection end of the first control switch is connected to a first pole of the power supply; a second connection end of the first control switch is connected to a first connection end of the second control switch; a second connection end of the second control switch is connected to a second pole of the power supply; and a second connection end of the first control switch serves as an output end of the power supply circuit; and/or
the resonant circuit comprises a coil and an in-series capacitor circuit, the in-series capacitor circuit comprises a first capacitor and a second capacitor connected in-series with the first capacitor, two ends of the in-series capacitor circuit are respectively connected to the first pole and the second pole of the power supply of the power supply circuit; one end of the coil is connected between the first capacitor and the second capacitor, and the other end of the coil serves as an input end of the heating module.

7. A heating device, comprising a control circuit and a heating circuit,
the heating circuit comprises:
at least two power supply circuits;
at least two heating modules;
a selection circuit, connected with the at least two power supply circuits and the at least two heating modules, and configured to select at least one of the at least two power supply circuits to be connected to each of the at least two heating modules, wherein selecting the at least one power supply circuit for one of the at least two power supply circuits does not affect selecting the at least one power supply circuit for another one of the at least two power supply circuits;
wherein the control circuit is configured to control the selection circuit in the heating circuit to select the at least one power supply circuit for supplying power to each of the at least two heating modules in the heating circuit.

8. The heating device according to claim 7, wherein the selection circuit comprises at least two selection switches; each of the at least two selection switches is connected to a respective one of the at least two heating modules and a plurality of the at least two power supply circuits; each of the at least two selection switches is configured to select one power supply circuit from the plurality of the at least two power supply circuits connected thereto to be connected to the respective heating module connected to the selection switch.

9. The heating device according to claim 8, wherein each of the at least two selection switches comprises a first connection end and a plurality of second connection ends; the first connection end is connected to an input end of the respective one heating module; each of the plurality of second connection ends is connected to an output end of a respective one of the at least two power supply circuits, the respective one of the at least two power supply circuits connected to one of the plurality of second connection ends is different from the respective one of the at least two power supply circuits connected to another one of the plurality of second connection ends;
when the first connection end is conducted to one of the plurality of second connection ends, the respective power supply circuit connected to the conducted one second connection end is conducted to the respective heating module connected to the selection switch, and the respective power supply circuit connected to any non-conducted second connection end of the plurality of second connection ends is disconnected to the respective heating module connected to the selection switch.

10. The heating device according to claim 8, wherein two or more of the at least two selection switches, which are connected two or more of the at least two heating modules, are connected a same one of the at least two power supply circuits; and/or
at least one of the at least two selection switches, which is connected to at least one of the at least two heating modules, is connected is connected to all of the at least two power supply circuits.

11. The heating device according to claim 7, wherein each of the at least two power supply circuits is an inverter circuit, and each of the at least two heating modules is a resonant circuit.

12. The heating device according to claim 11, wherein,
the inverter circuit comprises a power supply, a first control switch and a second control switch; a first connection end of the first control switch is connected to a first pole of the power supply; a second connection end of the first control switch is connected to a first connection end of the second control switch; a second connection end of the second control switch is connected to a second pole of the power supply; and a second connection end of the first control switch serves as an output end of the power supply circuit.

13. The heating device according to claim 11, wherein, the resonant circuit comprises a coil and an in-series capacitor circuit, the in-series capacitor circuit comprises a first capacitor and a second capacitor connected in-series with the first capacitor, two ends of the in-series capacitor circuit are respectively connected to a first pole and a second pole of the power supply of the power supply circuit; one end of the coil is connected between the first capacitor and the second capacitor, and the other end of the coil serves as an input end of the heating module.

14. The heating device according to claim 7, wherein the control circuit is configured to:
select a target power supply circuit for a respective one of the at least two heating modules from selectable power supply circuits of the respective heating module based on a required power of the respective heating module and/or based on a state of each of the selectable power supply circuits; and
control the selection circuit to connect the respective heating module to the target power supply circuit, wherein the selectable power supply circuits are power supply circuits that are connected to the selection circuit connected to the respective heating module.

15. The heating device according to claim 14, wherein an output power of the target power supply circuit of the respective heating module matches the required power of the respective heating module; and/or
the state of the power supply circuit comprises: the power supply circuit being in an idle state or in a non-idle state, wherein the idle state indicates that the power supply circuit is not currently connected to any of the at least two heating modules.

16. The heating device according to claim 15, wherein selecting the target power supply circuit for the respective one of the at least two heating modules from selectable power supply circuits of the respective heating module based on the required power of the respective heating module and/or based on the state of each of the selectable power supply circuits, comprises:
searching from the selectable power supply circuits of the respective heating module to determine whether an idle power supply circuit exists, wherein the idle power supply circuit is one of the selectable power supply circuits having an output power matching the required power of the respective heating module and being in the idle state;
in response to the idle power supply circuit existing, selecting the idle power supply circuit as the target power supply circuit for the respective heating module;
in response to the idle power supply circuit not existing, selecting, from the selectable power supply circuits, one power supply circuit which has the output power matching the required power of the respective heating module and is in an in-use state, as the target power supply circuit for the respective heating module.

17. The heating device according to claim 14, wherein the control circuit is further configured to control the selection circuit to connect at least a portion of the at least two heating modules having a same required power to a same one of the at least two power supply circuits.

18. The heating device according to claim 7, wherein, the heating device further comprises a detection circuit, the detection circuit is configured to: detect whether a to-be-heated target object exists in a region corresponding to each of the at least two heating modules; and generate, in response to the to-be-heated target object existing in any of the at least two heating modules, a trigger signal for the any heating module in which the to-be-heated target object exists;
the control circuit is configured to control, in response to the trigger signal, the selection circuit to connect the heating module in which the to-be-heated target object exists to at least one of the at least two power supply circuits.

19. The heating device according to claim 18, wherein the control circuit is further configured to control the selection circuit to connect a plurality of the at least two heating modules in which the same to-be-heated target object exists to the same power supply circuit.

20. The heating device according to claim 7, the heating device is an electromagnetic heating device.
